(19) United States
(12) Patent Application Publication
(10) Pub. No.: US 2009/0146839 A1
(43) Pub. Date: Jun. 11, 2009

(54) AUTOMATED METER READING SYSTEM AND METHOD THEREOF

(75) Inventors: Dasari Uday Kumar Reddy, Hyderabad (IN); Kathirisetti Satish, Hyderabad (IN); Chachan Navnit, Hyderabad (IN)

Correspondence Address: ABELMAN, FRAYNE & SCHWAB, 666 THIRD AVENUE, 10TH FLOOR, NEW YORK, NY, 10017, US

(73) Assignee: TANLA SOLUTIONS LIMITED, Hyderabad (IN)

(21) Appl. No.: 12/299,889

(22) PCT Filed: Aug. 21, 2006
(86) PCT No.: PCT/IN06/00302

§ 371 Date: Nov. 6, 2008

(51) Int. Cl. G08C 17/00

(52) U.S. Cl. 340/870.02

(57) ABSTRACT

An automated meter reading system and method include a plurality of communication nodes forming ad-hoc mesh network. The plurality of communication nodes collect utility usage data from utility meters. A controller station communicates with the ad-hoc mesh network, which dynamically routes the utility usage data to the controller station. A central monitoring station communicates with the controller station. The central monitoring station receives and processes the utility usage data from the controller station for the efficient and accurate billing and other accounting and management operations.

### CROSS-REFERENCE TO RELATED APPLICATIONS

This application is a 371 of international application number PCT/IN2006/000302, filed on Aug. 21, 2006.

### BACKGROUND OF THE INVENTION

1. Field of the Invention

The present invention relates to automated meter reading systems and methods thereof.

2. Description of the Related Art

Usage of utility commodities, such as, electricity, water, gas, steam, and the like, is conventionally determined by utility service providers using utility meters that measure utility usage. A periodic reading of the utility meter is necessary to determine the usage and to bill the consumer for the amount used. Normally, such utility meters are manually read by sending service personnel to each utility meter location. The manual reading of the utility meter is then entered into a billing system for generating a billing statement for a consumer. Such manual meter reading by service personnel is highly labor intensive, inefficient, unreliable, and very expensive. Moreover, manual reading of meters often results in additional costs related to human error. For example, a high bill caused by incorrect manual reading or estimated reading often motivates consumers to pay later, resulting in increased working capital requirements and corresponding expenses for a utility service provider. Also, incorrect manual readings or estimated readings lead to consumer complaints, thereby, involving additional costs (customer service call center costs, costs associated with routing and processing the complaints from the call center to the meter department, and the like).

Over the years, manual meter readings have been enhanced with the introduction of walk-by or drive-by reading systems that utilize radio communications, and the like, between the utility meters and mobile receiver units. For example, a utility service vehicle mounted with a mobile receiving unit or utility service personnel having a hand-held mobile receiving unit passes by a meter location to receive usage data from the meter. The usage data is then stored and later entered into a billing system for generating a billing statement for a consumer. Such systems reduce labor intensive work, usage data handling, and associated costs. However, such systems still require a manual visit to each meter location, and additional time involved in downloading usage data to a billing system. Also, realization difficulties may include prohibitive capital costs, i.e., vehicles, software and hardware requirements.

Recently, automated meter reading (AMR) systems have been developed for more efficient, accurate, and cost-effective meter readings. AMR systems employ technologies and methods for remotely reading a plurality of utility meters by installing or utilizing fixed networks that allow usage data to flow from a utility meter to a host computer having a billing system, without human intervention. AMR systems have several advantages over manual meter reading techniques. Worth noting among these advantages are the reliability, accuracy and regular availability of metering data, collected from hard-to-reach meter locations as well as from standard meter locations; higher customer security (no need to enter homes) and satisfaction (accurate bills); and reduced cost of customer service call center and service house calls for settling billing disputes.

AMR systems have used existing telephone lines and power lines to communicate usage data to a billing system of a utility service provider. For example, AMR systems may use a dial-up modem in a collection unit (attached to a utility meter) to dial a remote billing system and transmit usage data via telephone lines. In general, these systems incorporate an auto-dial, auto-answer modem at each meter location to receive interrogation signals from the telephone line and to formulate and transmit meter readings via the telephone line to the utility service provider. These systems record information on utility usage and periodically dial into a central office to report the utility usage for recording and billing purposes. This methodology provides two-way communication and control between the utility meter and the billing system. The modem shares the telephone line with the consumer's normal usage, such as, incoming and outgoing voice communications. However, such sharing requires that the system be able to recognize when the telephone line is in use, and to delay demanding use of the telephone line, until it is free. Additionally, steps must be taken to prevent the data communications system from interfering with other uses and to prevent other uses from corrupting the transmitted data.

Another example is the use of power lines as a carrier medium. This approach connects the utility meter through power lines and relays the meter reading to a billing system of a utility service provider over the power lines. This approach, however, may require complicated infrastructure to be installed. Power lines may receive a large amount of noise, thereby, increasing the possibility of losing usage data from such interferences in the power lines. Signal-cleaning filters, that are generally very expensive, may be installed periodically along the power lines to attenuate the noise. Moreover, the connections are often at line voltage, resulting in a complicated and time-consuming installation process.

More recently, wireless technologies have been most commonly used in AMR system implementation due to the ease of the installation process, and in many cases, low initial and operating costs of the system. Such systems have wireless networks that are typically installed in a point-to-point loop configuration or additionally multi-point loop configuration, and are used to collect information from and to disseminate information to individual nodes of the network. In conventional wireless networks, using a point-to-point loop configuration, each node in the network is interconnected, and each node communicates with two neighboring nodes. Information or commands are passed from node to node around the point-to-point loop, until they arrive at a master node. The master node is used to communicate information that is gathered to a central station or to accept and distribute information received from a central station throughout the network.

However, such conventional wireless networks, have several limitations. For example, because the conventional wireless networks generally have a point-to-point loop configuration, the integrity of entire network may be affected, even when a single node is disabled. Moreover, if the master node of such a conventional wireless network is disabled, the network may become isolated.

Other variations in wireless technologies for AMR system implementation include use of data channels in wireless telephone systems to transmit usage data to a remote billing system via a wireless telephone network, such as, PCS, satellite, or cellular. Some other methodologies include use of low earth orbiting satellites. However, building, launching and maintaining a fleet of satellites is very expensive.

None of the above approaches discloses any means to overcome the above-mentioned drawbacks associated with meter reading systems. Accordingly, what is needed is a meter reading system for automatic transfer of usage data from a utility meter to a billing system of a utility service provider in a fast, easy, convenient, reliable, and inexpensive manner, for efficient and accurate billing, and other accounting and management operations.

### SUMMARY OF THE INVENTION

In view of the foregoing disadvantages inherent in the prior art, the general purpose of the present invention is to provide a system and method for automated meter reading, to include all the advantages of the prior art, and to overcome the drawbacks inherent therein.

In one aspect, the present invention provides an automated meter reading system. The automated meter reading system, comprises: a plurality of communication nodes configuring an ad-hoc mesh network, the plurality of communication nodes capable of collecting utility usage data from utility meters; at least one controller station operably communicating with the ad-hoc mesh network, wherein the ad-hoc mesh network is capable of dynamically routing the utility usage data to the controller station; and a central monitoring station operably communicating with the controller station, the central monitoring station capable of receiving the utility usage data from the controller station and processing the utility usage data.

In another aspect, the present invention provides an ad-hoc mesh network system for automated meter reading, comprising: a plurality of communication nodes configuring at least one ad-hoc mesh network, the plurality of communication nodes capable of collecting utility usage data from utility meters, wherein the ad-hoc mesh network is capable of dynamically routing the utility usage data to a central monitoring station, and wherein the central monitoring station is capable of processing the utility usage data for billing, tracking, and forecasting.

In yet another aspect, the present invention provides a method for automated meter reading, comprising: providing a plurality of communication nodes operably communicating with utility meters; transmitting utility usage data from the utility meters to the plurality of communication nodes; configuring an ad-hoc mesh network using the communication nodes; dynamically routing the utility usage data to a controller station via the ad-hoc mesh network; transmitting the utility usage data from the controller station to a billing station; and processing the utility usage data by the billing station for billing, tracking, and forecasting.

These together with other aspects of the present invention, along with the various features of novelty that characterize the invention, are pointed out with particularity in the claims annexed hereto and forming a part of this disclosure. For a better understanding of the invention, its operating advantages, and the specific objects attained by its uses, reference should be made to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, wherein:

FIG. 1 is block diagram of an automated meter reading system 100, according to an exemplary embodiment of the present invention;

FIG. 2 is a block diagram of a communication node 120 operably coupled to a utility meter 110, according to an exemplary embodiment of the present invention;

FIG. 3 illustrates the interconnection of the communication node 120 with the utility meter 110, according to an exemplary embodiment of the present invention;

FIG. 4 is a block diagram of a controller station 150, according to an exemplary embodiment of the present invention;

FIG. 5 illustrates a data message structure 172 of utility usage data, according to an exemplary embodiment of the present invention;

FIG. 6 illustrates a command message structure 174 of command data, according to an exemplary embodiment of the present invention; and

FIG. 7 illustrates a broadcast message structure 176 of broadcast data, according to an exemplary embodiment of the present invention.

Like reference numerals refer to like parts throughout several views of the drawings of the present invention.

### DETAILED DESCRIPTION OF THE INVENTION

The present invention is related to international application number PCT/IN2006/000302, filed on Aug. 21, 2006, which is incorporated herein by reference in its entirety.

The exemplary embodiments described herein in detail for illustrative purposes are subject to many variations in structure and design. It should be emphasized, however, that the present invention is not limited to a particular system and method for automated meter reading, as shown and described. It is understood that various omissions or substitutions of equivalents are contemplated as circumstances may suggest or render expedient, but are intended to cover the application or implementation without departing from the spirit or scope of the claims of the present invention.

As used herein, the terms “first,” “second”, and so forth, herein do not denote any order, quantity, or importance, but rather, are used to distinguish one element from another, and the terms “a” and “an” herein do not denote a limitation of quantity, but rather, denote the presence of at least one of the referenced item.

The present invention provides a system and method for automated meter reading. The present invention employs an ad-hoc mesh network of communication nodes capable of collecting utility usage data (utility meter reading) from utility meters and transmitting the utility usage data to a central monitoring station for efficient and accurate billing, and other accounting and management operations.

The ad-hoc mesh network of the present invention significantly lowers the cost of the two-way communication between the utility meters and the central monitoring station, and further ensures easy installation of the system. The system of the present invention provides fault tolerant failsafe mechanisms, encryption, and compression techniques for automatic transmission of utility usage data in a fast, secure, and reliable manner.

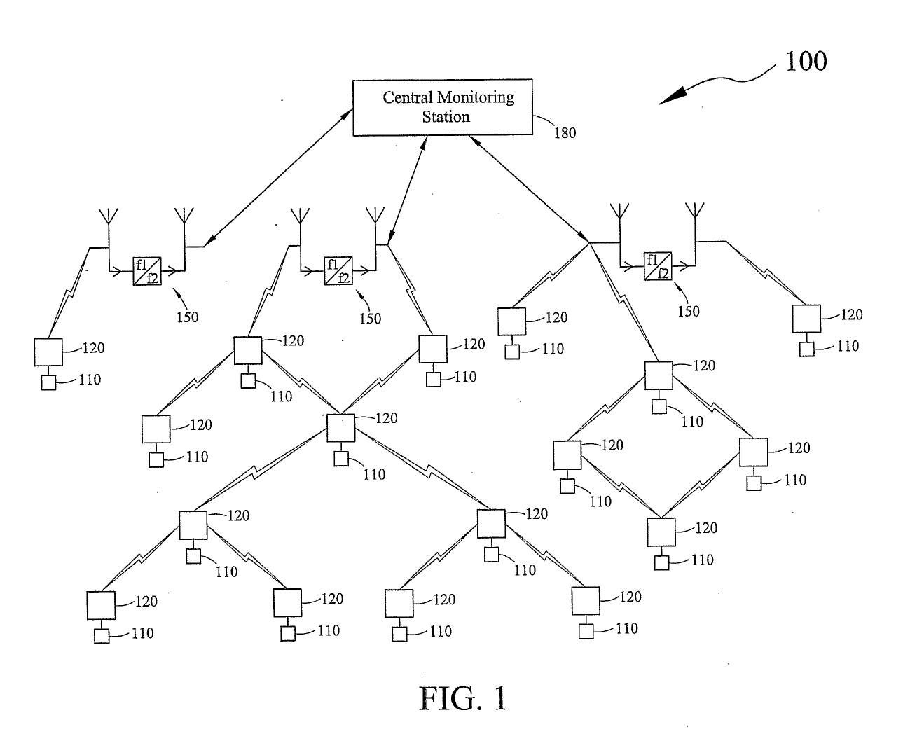

Referring to FIGS. 1-7, an automated meter reading system 100 (hereinafter referred to as, system 100) is shown. The system 100 comprises: a plurality of communication nodes 120 configuring at least one ad-hoc mesh network, the communication node 120 is communicatively coupled to at least one utility meter 110; at least one controller station 150 capable of communicating with the ad-hoc mesh network; and a central monitoring station 180 (also referred to as billing station) in operative communication with the controller station 150.

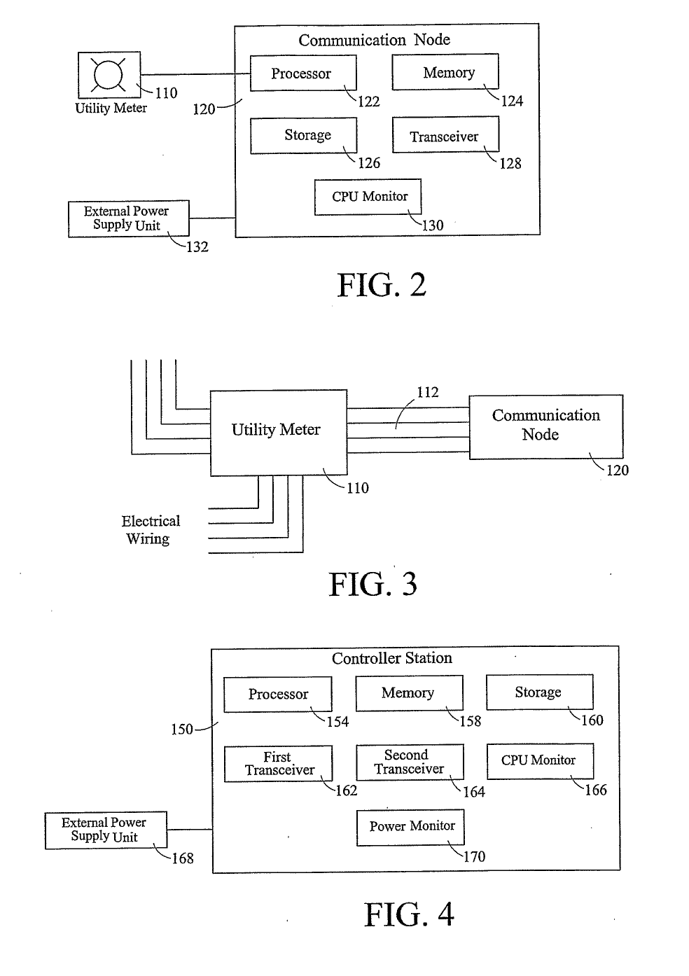

The communication node 120 may take the form of a hardware device comprising a processor 122, a memory 124, a storage 126, and a transceiver 128 (See FIG. 2). The processor 122 is capable of executing programmable instructions for performing the operations of the communication node 120. The processor 122 may be a microcontroller, for example, an integrated chip that has all the components of a controller, i.e., a central processing unit (CPU), random access memory (RAM), read only memory (ROM), input/output interfaces, and timers. Preferably, the memory 124 is a random access memory or other type of dynamic storage device, sufficient to hold the necessary programmable instructions and data structures located on the communication node 120. The storage 126 may include a fixed and/or removable storage, such as, tape drives, floppy discs, removable memory cards, or optical storage. In one embodiment, the storage 126 includes a flash memory for permanently storing data. The transceiver 128 may be a wireless transceiver, such as, a radio frequency (RF) modem. Preferably, the transceiver 128 is a low power/low range RF modem. The transceiver 128 is capable of transmitting and receiving data for a distance of about 1000 meters. The communication node 120 may further include a CPU monitor 130 for monitoring the health of the processor 122. An external power supply unit 132 may be used to supply power for operating the communication node 120.

Each communication node 120 is operatively coupled to a utility meter 110. The utility meter 110 is a device capable of measuring utility usage data of some utility commodity, for example, electricity, gas, water, steam, and the like. The utility meter 110 may be installed at consumer premises, such as, a home, or a business location to indicate the utility usage by such consumer premises through an analog or digital signal. The communication node 120 is capable of collecting analog or digital data of the utility usage from the utility meter 110. The communication node 120 may be enabled to periodically receive the utility usage data from the utility meter 110, and store the utility usage data in the memory 124. The communication node 120 may provide an accurate record of the exact day and time the utility usage data has been collected. The communication node 120 may record a plurality of parameters in various combinations, for example, for an electric motor, the parameters may include all phase voltages, currents, power, energy usage, power demand, power factor, time of use, interval recordings of energy usage, power quality information, power outage information, and the like. Alternatively, the parameters may change for a gas meter, or a temperature sensor. Also, the utility usage data collected may be instantaneous, or may be collected over a period of time.

In one embodiment, the utility meter 110 may be interfaced or coupled with sensors capable of providing utility usage data to the communication node 120. The communication node 120 may be housed within the utility meter 110. Alternatively, the communication node 120 may be housed in a separate enclosure and mounted either adjacent to the utility meter or nearby building structure, and then connected to the utility meter 110 through a communication interface 112 (See FIG. 3). The communication interface 112 may be a wired link, for example, RS232, RS485, RJ45; or a wireless link, for example, optical, infrared, and the like.

The controller station 150 includes a host computer capable of processing the utility usage data received from the communication nodes 120. The host computer may take the form of a server computer comprising processor 154, memory 158, storage 160, a first transceiver 162, and a second transceiver 164 (See FIG. 4). Processor 154 is capable of executing programmable instructions for performing the operation of the controller station 150. Processor 154 may be a microcontroller, for example, an integrated chip that has all the components of a controller, i.e., a central processing unit (CPU), random access memory (RAM), read only memory (ROM), input/output interfaces, and timers. Preferably, the memory 158 is a random access memory or another type of dynamic storage device, sufficient to hold the necessary programming and data structures located on the controller station 150. The storage 160 may include a fixed and/or removable storage, such as, tape drives, floppy discs, removable memory cards, or optical storage. In one embodiment, the storage 160 includes a flash memory for permanently storing the data. The first transceiver 162 may be a wireless transceiver, such as, a radio frequency (RF) modem, capable of establishing communication between the controller station 150 and the communication node 120. The second transceiver 164 may be a GSM modem, or PSTN modem, or a GPRS modem, capable of establishing communication between the controller station 150 and the central monitoring station 180 using a specific protocol such as TCP/IP, and the like. The host computer may further include a CPU monitor 166 for monitoring the health of the processor 154. The controller station 150 may include an external power supply unit 168 to supply power for the operation of the host computer. Optionally, the host computer may include a power monitor 170 to control and monitor the amount of power supplied to the host computer from the external power supply unit 168.

The controller station 150 may collect the utility usage data at predetermined intervals from the communication nodes 120, and sends the collected utility usage data to the central monitoring station 180. The controller station 150 may use a public network, such as, public switched telephone network (PSTN), global system for mobile communications (GSM) network, general packet radio service (GPRS) network, and the like, to establish communication with the central monitoring station 180. The controller station 150 may use Transmission Control Protocol/Internet Protocol (TCP/IP) for establishing communication with the central monitoring station 180 in a secure mode. When the controller station 150 contacts the central monitoring station 180, the central monitoring station 180 checks a unique digital key of the controller station 150 with a set of existing keys at the central monitoring station 180, and thereafter, authenticates the connection.

The central monitoring station 180 may be implemented as a software program capable of processing the utility usage data received from the utility meters 110, for the purpose of billing, tracking, and forecasting of the utility usage of consumers across a geographical area, In one embodiment, the central monitoring station 180 may reside in a high end server computer comprising Internet connectivity having a public IP address for GPRS, telephone connectivity for PSTN, and mobile phone connectivity for GSM data call.

The communication nodes 120 may function as a receiver, a repeater, and a transmitter of the utility usage data, thereby creating a communications network, more specifically, an ad-hoc mesh network capable of dynamically routing the utility usage data to the controller station 150. Upon receiving a request from the controller station 150 or at scheduled intervals, a communication node 120 may send the utility usage data from the utility meter 110 to which it is associated to a next communication node 120. The communication node 120, acting as a repeater, may store the utility usage data received from another communication node 120 and forwards the received utility usage data either to a next communication node 120 or directly to the controller station 150. Accordingly, the ad-hoc mesh network defines a path (also referred to as route) based on a shortest reliable path algorithm, for routing the utility usage data from a utility meter 110 to a controller station 150 at a given point of time.

The ad-hoc mesh network has self-healing characteristics, i.e., the ad-hoc mesh network is capable of adapting itself to failure of at least one of the communication nodes 120. For example, during transmission of utility usage data, if one or more of the communication nodes 120 fail, then the ad-hoc mesh network removes the failed communication nodes and defines an alternate path for routing the utility usage data to the controller station 150. When the failed communication nodes comes back alive, then the ad-hoc network integrates the failed communication node back into the ad-hoc mesh network and the other communication nodes 120 may once again start using the original path for transmission of utility usage data.

Additionally, the ad-hoc mesh network has self-determining characteristics, i.e., the ad-hoc mesh network is capable of determining newly added communication nodes, integrating the newly added communication nodes into the ad-hoc mesh network, and updating existing paths for transmitting the utility usage data to the controller station 150. The ad-hoc mesh network may accommodate additional communication nodes 120, when additional communication nodes 120 are interfaced with utility meters 110. Further, the configuration of the ad-hoc mesh network may be divided into a plurality of radially expanding network levels i.e., a first network level, a second network level, and so forth, such that, the communication nodes 120 at the first network level may be able to communicate with the communication nodes 120 at the second network level. Similarly, communication nodes 120 at the second network level may be able to communicate with communication nodes 120 at the third network level.

The ad-hoc mesh network enables one of the communication nodes 120 to transfer the utility usage data to another of the communication node 120. The communication node 120 may transmit the utility usage data to the host computer of the controller station 150 using a relatively lower range of frequency, for example, at 433 MHz. Alternatively, the utility usage data may be transmitted at 868 MHz, or at 900 MHz.

In one embodiment, a controller station 150 may directly communicate with the surrounding controller stations 150, and collect the utility usage data gathered by the surrounding controller stations 150. In the event of the failure of one of the controller stations 150, another controller station 150 is enabled to send the utility usage data collected by the failed controller station 150 to the central monitoring station 180.

The transmission of utility usage data is packet based. Such packets are referred to as data packets, for the purpose of description. During transmission process, before sending an actual packet, a first communication node 120 may send a preamble comprising a sequence of 1's and 0's denoting the arrival of the actual packet. A second communication node 120, upon receiving the preamble, waits for the actual packet to be received. After the preamble is sent, the first communication node 120 sends data packets to the second communication node 120. Periodically, the second communication node 120 may also receive data packets from other communication nodes 120. The second communication node 120 accepts the data packets received from other communication nodes 120, and stores them in the memory 124. At predetermined time intervals, the second communication node 120 takes the data packets stored in the memory 124, and forwards them to a next communication node 120 that is reliably closer to the destination. The data packet hops between different communication nodes 120, until the data packet reaches the destination, i.e. the controller station 150.

The transmission of data packets from one communication node 120 to another communication node 120 may be governed by methodologies that include, but are not limited to, guaranteed delivery, dynamic window availability for transmission, and frequency hopping.

Guaranteed delivery ensures that a second communication node 120 (receiver communication node) sends an acknowledgment of every data packet received by the second communication node 120. If the second communication node 120 fails to send the acknowledgment due to either the non-arrival of the data packet, or arrival of the erroneous data packet, then, the data packet is retransmitted by the first communication node 120 to the second communication node 120. The acknowledgment of the arrival of the data packet may be in the form of a cyclic redundancy code (CRC) check of the received data packet along with the number of bytes of data received including the serial number (sequence number) of the received data packet. The communication node 120 may not accept a data packet if the available routes for further transmission are unreachable.

Dynamic window availability for data packet transmission ensures that, during the course of stabilization of ad-hoc mesh network, every communication node 120 receives a unique ‘time window’ (a transmission window) for transmitting the data packets to a communication node 120 at a higher network level, thereby, preventing the interference of transmission of utility usage data from nearest range of communication nodes 120. The transmission windows may be shifted to a next available communication node 120 during busy time i.e., high traffic. The availability of transmission windows for a specific communication node 120 depends on the density (number of communication nodes 120) of the ad-hoc mesh network. The amount of traffic in each communication node 120 of the ad-hoc mesh network is constantly monitored, and the transmission windows are shifted from a communication node 120 handling high traffic to a communication node 120 with less traffic, i.e., after every transmit cycle (transmit interval), the transmission windows are reserved for a specific communication node. For example, if the transmit interval for all communication nodes 120 is 15 minutes, then, the dynamic window availability ensures that all transmissions in the ad-hoc mesh network happen within the 15 minute transmit interval and the same sequence is repeated after 15 minutes.

The communication nodes 120 may use frequency hopping to attain multiple transmissions of data packets during the same transmission window. Since the controller station 150 receives data packets periodically, the analysis of data packets assists the controller station 150 to determine the exact tree hierarchy of the communication nodes forming the mesh network, i.e., the controller station 150 identifies the exact location of each communication node 120 within the communication network, and formulates a route information including paths taken by the data packets to arrive at the controller station 150. When the data packets (command data), are to be sent from the controller station 150 to the communication node 120, the controller station may use the route information to send data packets to a first communication node 120 in the path. The first communication node 120 may then receive data packets and forwards the data packets to a next communication node 120 at a next lower network level as per the route information detailed in the packet, and so forth, such that, the data packets reach the intended communication node 120 (destination).

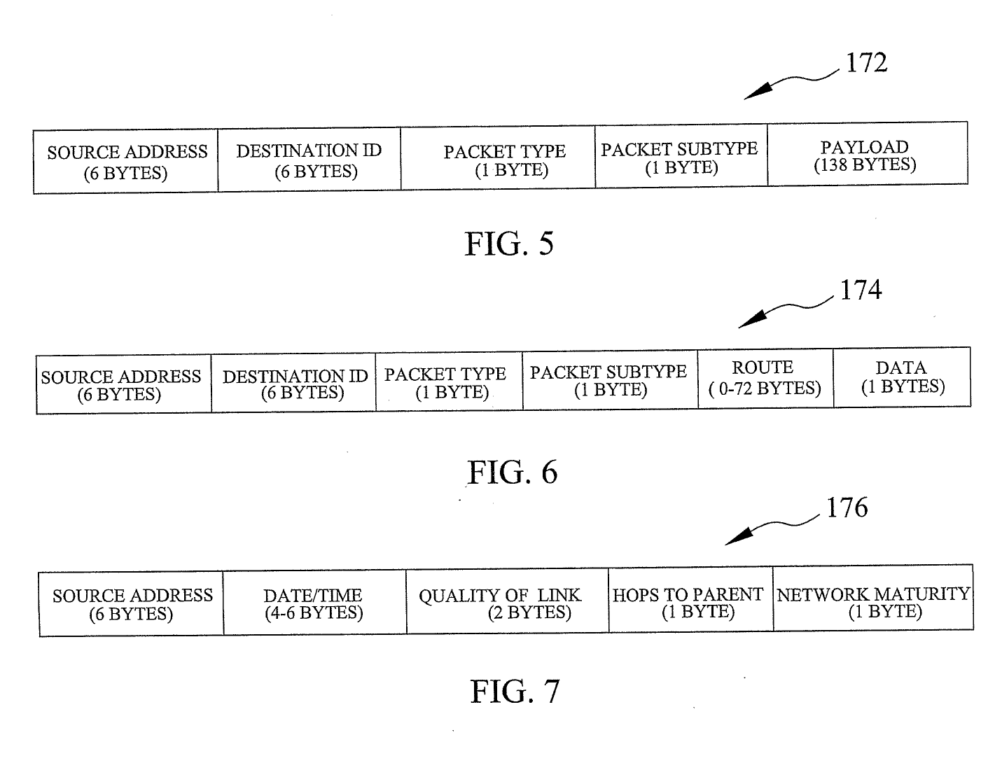

The data packet may comprise utility usage data (meter reading data) or command data. For the utility usage data, the destination is always the controller station 150. As shown in FIG. 5, data packets used for utility usage data comprise a data message structure 172 having a source address of 6 bytes, a destination identifier of 6 bytes, a packet type of 1 byte, a packet subtype of 1 byte, and a payload of 138 bytes. The command data in data packets represents commands that are sent to the communication nodes 120. Suitable commands may include, but are not limited to, change of broad cast interval, change of transmission interval, change of meter reading interval, and change of network maturity threshold. As shown in FIG. 6, in one embodiment, data packets used for command data comprise a command message structure 174 having a source address field of 6 bytes, a destination identifier field of 6 bytes, a packet type field of 1 byte, a packet subtype field for 1 byte, a route field of 0 to 72 bytes, and a data field of 1 byte. The communication node 120 may update its parameter upon receiving the data packet having command data.

The controller station 150 may construct and send a broadcast packet to the ad-hoc mesh network periodically. As shown in FIG. 7, in one embodiment, broadcast data of the broadcast packet may comprise a broadcast message structure 176 having a source address field of 6 bytes, date-time synchronization data field of 4 to 6 bytes, quality of link field of 2 bytes, hops to parent field of 1 byte, and network maturity level field of 1 byte. The communication nodes 120 within range may receive and process the broadcast packet. Each communication node 120 maintains a table of routes along with quality in hierarchical order. On reception of such broadcast packets, a communication node 120 may perform a comparison with the existing routes, and accordingly, updates the existing route with the new route, if the communication node 120 determines that the new route is shorter than the existing route, i.e., each communication node 120 maintains the address of a next communication node 120 closer to the controller station 150. The above process of receiving the broadcast packet and updating the existing route is performed by each communication node 120 at regular intervals. For example, after a period of time, each communication node 120 may have 3-5 alternate routes to the controller station 150. The communication node 120 never performs a broadcast, if the communication node 120 does not have a mature level of routes to the controller station 150 and has tested a route at least once. The broadcast interval is determined by the maturity of the ad-hoc mesh network and as the ad-hoc mesh network matures, the broadcast interval keeps reducing. As used herein, ‘ad-hoc mesh network maturity’ is defined by the number of routes available to each node. This ensures that the ad-hoc mesh network matures very quickly and broadcast packets do not overwhelm the ad-hoc mesh network when the communication nodes 120 in the ad-hoc mesh network are large in number. Over a period of time, all communication nodes 120 within the ad-hoc mesh network may have multiple routes to the controller station 150. The communication node 120 takes the data packet one at a time and sends it to the communication node 120 at a higher network level, which in turn, at its particular transmission time, sends the data packet further to a next higher network level, and so forth, until the data packet reaches the controller station 150.

On receiving the data packet from the communication nodes 120, the controller station 150 verifies the authenticity of the data packet, and then, stores it in a memory 158 of the controller station 150. At predetermined time intervals, the controller station 150 connects to the central monitoring station 180 via a specified protocol, and transmits the received data packets to the central monitoring station 180. The controller station 150 may also receive data packets (command data) for time and date synchronization, and data packets destined for a particular communication node from the central monitoring station 180. On reception of the date and time packet, the controller station 150 may update the data and time of its internal clock. The controller station 150 forwards the data packet having command data destined for a particular communication node 120 by extracting the address from the data packet, and sends the data packet to the nearest communication node, i.e., next hop, until the data packet reaches the destination.

The central monitoring station 180, upon receiving the data packet from the communication node 120, checks for authenticity from a source address field of the data packet (ID of controller station 150). Further, the central monitoring station 180 checks for accuracy of the data packet from a CRC checksum field of the data packet. After verifying the authenticity and accuracy of the data packet, the central monitoring station 180 processes the received data packet. The central monitoring station 180 decrypts the data packet encrypted by the communication nodes 120, and thereafter analyzes the data packet for accuracy of the data by checking the data ranges with the previous and historical values. Further, the central monitoring station 180 analyzes the data packet, and determines whether the utility meter has been tampered with by the consumer by checking the vector values of data. In one embodiment, the central monitoring station 180 may check for six different types of tampering in terms of phase reversals, meter bypass, and the like. Subsequently, the central monitoring station 180 stores the utility usage data into a database. The database may be used for further analysis such as outage monitoring to monitor areas, where power outage has occurred, line condition monitoring to check for frequency and voltage aberrations, and power demand forecast.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions or substitutions of equivalents are contemplated as circumstance may suggest or render expedient, but are intended to cover the application or implementation without departing from the spirit or scope of the claims of the present invention.

1. An automated meter reading system, comprising:
a plurality of communication nodes configuring an ad-hoc mesh network, the plurality of communication nodes capable of collecting utility usage data from utility meters;
at least one controller station operably communicating with the ad-hoc mesh network, wherein the ad-hoc mesh network is capable of dynamically routing the utility usage data to the controller station; and
a central monitoring station operably communicating with the controller station, the central monitoring station capable of
receiving the utility usage data from the controller station, and
processing the utility usage data.

2. The system of claim 1, wherein the ad-hoc mesh network is capable of dynamically routing the utility usage data by defining an alternate path for routing the utility usage data to the controller station, in the event of failure of at least one of the plurality of the communication nodes.

3. The system of claim 1, wherein the ad-hoc mesh network is capable of dynamically routing the utility usage data by determining newly added communication nodes, integrating the newly added communication nodes into the ad-hoc mesh network, and updating existing routes for transmitting the utility usage data to the controller station.

4. The system of claim 1, wherein the communication node is disposed outside the utility meter, and connected to the utility meter through a communication interface.

5. The system of claim 4, wherein the communication interface is selected from the group consisting of wired links, wireless links, and combinations comprising at least one of the foregoing.

6. The system of claim 1, wherein the controller station uses a public network for establishing communication with the central monitoring station, the public network is selected from the group consisting of PSTN networks, GPRS networks, GSM networks, and combinations comprising at least one of the foregoing.

7. The system of claim 1, wherein the controller station uses a TCP/IP connection for establishing communication with the central monitoring station.

8. The system of claim 1, wherein the utility meter is coupled with a sensor capable of providing utility usage data to at least one of the plurality of communication nodes.

9. The system of claim 1, wherein the central monitoring station includes programmable instructions for billing, tracking, and forecasting of the utility usage data.

10. The system of claim 1, wherein the communication node transmits the utility usage data to the controller station at a frequency selected from the group consisting of 433 MHz, 868 MHz, and 900 MHz.

11. The system of claim 1, wherein one of the controller stations operatively communicates with another of the controller stations, and collects the utility usage data from another of the controller stations.

12. The system of claim 1, wherein the utility usage data is re-transmitted from a sender communication node of the plurality of communication nodes to a receiver communication node of the plurality of communication nodes, until an acknowledgment indicating the reception of the utility usage data is received from the receiver communication node.

13. The system of claim 1, wherein each of the plurality of communication nodes receives a transmission window for transmitting the utility usage data to other communication nodes of the plurality of communication nodes, thereby preventing the interference of transmission of utility usage data from other communication nodes.

14. The system of claim 13, wherein the communication node uses frequency hopping to attain multiple transmissions of utility usage data during the transmission window.

15. The system of claim 1, wherein the communication node comprises a radio frequency modem capable of transmitting and receiving utility usage data for a distance of about 1000 meters.

16. The system of claim 1, wherein the communication nodes function as a receiver, repeater, and transmitter of utility usage data.

17. The system of claim 1, wherein the controller station comprises a radio frequency modem capable of establishing communication between the controller station and the ad-hoc mesh network.

18. The system of claim 1, wherein the controller station comprises a transceiver capable of establishing communication between the controller station and the central monitoring station, wherein the transceiver is selected from the group consisting of GSM modems, PSTN modems, GPRS modems, and combinations comprising at least one of the foregoing.

19. The system of claim 1, wherein the controller station constructs and sends a broadcast packet to the ad-hoc mesh network periodically, the broadcast packet comprising a broadcast message structure having a source address field, a date-time synchronization field, a quality of link field, a hops to parent field, and a network maturity level field.

20. The system of claim 19, wherein the communication node receives the broadcast packet having information of new routes, and updates existing routes with the new routes, upon determining that the new routes are shorter than the existing routes.

21. The system of claim 1, wherein the utility usage data comprises a message structure having a source address field, a destination identifier field, a packet type field, a packet subtype field, and a payload field.

22. The system of claim 1, wherein the controller station sends a command data to the communication nodes, the command data comprising a message structure having a source address field, a destination identifier field, a packet type field, a packet subtype field, a route field, and a data field.

23. The system of claim 22, wherein the command data includes commands selected from the group consisting of change of broadcast interval, change of transmission interval, change of meter reading interval, change of network maturity threshold, and combinations comprising at least one of the foregoing.

24. The system of claim 1, wherein the utility meter is selected from the group consisting of electricity meters, gas meters, water meters, steam meters, and combinations comprising at least one of the foregoing.

25. An ad-hoc mesh network system for automated meter reading, comprising:
a plurality of communication nodes configuring at least one ad-hoc mesh network, the plurality of communication nodes capable of collecting utility usage data from utility meters,
wherein the ad-hoc mesh network is capable of dynamically routing the utility usage data to a central monitoring station, and
wherein the central monitoring station is capable of processing the utility usage data for billing, tracking, and forecasting.

26. The system of claim 25, wherein the ad-hoc mesh network is capable of dynamically routing the utility usage data by defining an alternate path for routing the utility usage data to the controller station, in the event of failure of at least one of the plurality of the communication nodes.

27. The system of claim 25, wherein the ad-hoc mesh network is capable of dynamically routing the utility usage data by determining newly added communication nodes, integrating the newly added communication nodes into the ad-hoc mesh network, and updating existing routes for transmitting the utility usage data to the controller station.

28. The system of claim 25, wherein at least one of the communication node is capable of collecting utility usage data associated with other communication nodes, and transmitting the utility usage data to the central monitoring station.

29. A method for automated meter reading, comprising:
providing a plurality of communication nodes operably communicating with utility meters;
transmitting utility usage data from the utility meters to the plurality of communication nodes;
configuring an ad-hoc mesh network using the communication nodes;
dynamically routing the utility usage data to a controller station via the ad-hoc mesh network;
transmitting the utility usage data from the controller station to a billing station; and
processing the utility usage data by the billing station for billing, tracking, and forecasting.

30. The method of claim 29, wherein the dynamically routing of utility usage data comprises defining an alternate path for routing the utility usage data to the controller station, in the event of failure of at least one of the plurality of the communication nodes.

31. The system of claim 29, wherein the dynamically routing of the utility usage data comprises determining newly added communication nodes, integrating the newly added communication nodes into the ad-hoc mesh network, and updating existing routes for transmitting the utility usage data to the controller station.
